(19) United States
(12) Patent Application Publication
(10) Pub. No.: US 2023/0238846 A1
(43) Pub. Date: Jul. 27, 2023

(54) NEW METHODOLOGY FOR IMPROVING ELECTRIC MOTOR EFFICIENCY

(71) Applicant: Motor, Inc., Cody, WY (US)

(72) Inventor: Steven Michael MURPHY, Cody, WY (US)

(21) Appl. No.: 18/101,533

(22) Filed: Jan. 25, 2023

Related U.S. Application Data
(60) Provisional application No. 63/303,424, filed on Jan. 26, 2022.

(51) Int. Cl. H02K 3/18; H02K 21/20

(52) U.S. Cl. CPC H02K 3/18; H02K 21/20

(57) ABSTRACT

Systems and methods here may be used to improve the efficiency of electric motors by increasing the number of windings of coils included in electric motors.

### CROSS REFERENCE TO RELATED APPLICATIONS

The present application claims priority to U.S. Provisional Patent No. 63/303,424 filed on Jan. 26, 2022 and entitled “A NEW METHODOLOGY FOR IMPROVING ELECTRIC MOTOR EFFICIENCY”, the entirety of which is incorporated by reference herein.

### TECHNICAL FIELD

This application relates to an electric motor and an electric motor design.

### BACKGROUND

The modern electric motor was first invented by Michael Faraday in 1821, about 200 years ago. Jedlik in 1827 was the first to build a motor with a stator, rotor, and commutator. Tesla brought us AC motors in 1888. There followed the development and evolution of electric motors, both DC and AC, to the current day. Over the decades, the type of DC and AC motors have frozen into sets, so that text books and college courses could be written to describe and reveal their inner workings. Advance after advance resulted in motors that can operate at 95-97 percent efficiency. However, the coil design has been largely unchanged for over 200 years. New coil designs are needed to produce more efficient motors.

### SUMMARY

Described herein are designs of electric motor coils that use less current but can generate roughly the same amount of magnetic field. The coil designs can provide a 1.5 to 4.0 times efficiency improvement in electric motors by reducing the current needed to power a motor without magnetic force loss. Along with current reductions, heat generated via “I squared R” losses can proportionately be reduced. The specification of the new coil designs can be predominately limited to the allowable inductance but the disclosed coil designs deliver significant gains in efficiency despite these inductance limitations.

### BRIEF DESCRIPTION OF THE DRAWINGS

FIG. 1 illustrates an electric motor including a coil, according to various embodiments described herein.

FIG. 2 illustrates a coil of N windings, according to various embodiments described herein

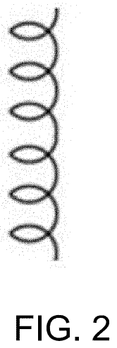

FIG. 3 illustrates a coil of 2N windings, according to various embodiments described herein.

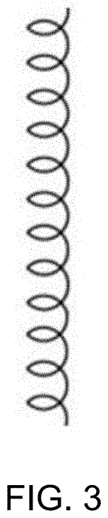

FIG. 4 provides the meaning of the a, b, c variables in Wheeler's Formula for the estimation of Inductance in a coil.

### DETAILED DESCRIPTION

### Overview

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known structures, timing protocols, software operations, procedures, and components have not been described in detail so as not to unnecessarily obscure aspects of the embodiments of the invention.

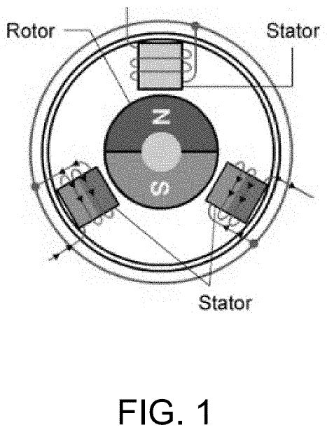

Described herein are electric motors that includes a new coil design. FIG. 1 illustrates an embodiment on an electric motor used to power a car or other vehicle. In most cases, the coils included in a stator that is positioned over the rotor. To power the motor, a magnetic field is generated by electric current that flows through the coils. The magnetic field turns the rotor to provide mechanical power. The electric motor includes commutators that include electrical connections that connect the coils of the stator to a battery or other electrical power source. One or more brushes on the commutator may facilitate a connection between the coils and the power source. The electric motor designs described herein include a new coil design that improves the efficiency of the electric motor by generating a magnetic field using less current relative to conventional electric motors.

To illustrate the advantage provided by the new coil design, two different coil designs will be compared. A first coil design (i.e., design A) may include N turns, with a total length of wire of L. A second coil design (i.e., design B) may have the same wire gauge as design A, but will consist of 2N turns, and its total length will be roughly 2 L because adding wire to the coil, may increase the radius of the circle around which the wire is being wound, and therefore, the length of wire required is slightly increased. Any length of wire can be used as long as design B has twice as many turns as design A.

The additional coils of design B increase the resistance of the coil. For example, design B described above will have roughly twice the resistance of design A. If both coils will have the same voltage applied to them, the current through design B will be roughly half that of design A. We note here that both A and B will generate roughly the same magnetic field when voltage is applied. The solenoid equation shown below (Equation AA: See “Design of Rotating Electrical Machines 2^{nd} Edition”, p. 4) illustrates that design A and design B both generate the same magnetic field (B):

B=μ₀k_{w}NI

This function can be defined with a denominator of the total magnetic circuit path, which gets thrown in with k_{w}. In expanding the number of turns in a coil, it can be attempted to minimize the magnetic circuit path, or try to minimize the growth of the circuit path.

Where N=the number of turns, I is the current, and to is the permeability constant of air/vacuum, 4π(1×10⁻⁷) Vs/Am. This equation leaves out the length of the magnetic flux path for simplicity. This equation also ignores the flux length, which is much less a factor when the coil core isn't air, but rather laminated soft iron core material. For purposes of the example above, K_{w} is number less than or equal to 1, that accounts for less than perfect linkages in inductance.

When equation 1 is applied to the coil design A and coil design B above the magnetic field (B) will be the same for both designs because when the constants are removed coil A reduces to N*I. Design B doubles the number of windings in the coil (N) which halves the current resulting in (2*N)*(½*I), which is simplified to NI.

Accordingly, increasing the number of windings in design B by 2× increases the length of the wire by roughly 2×, and the extra resistance provided by the longer wire decreases the current by about the same factor as shown in Equation BB below:

V=IR, or, in this case I=V/R.

If V is kept the same, and R is doubled (e.g., I=V/2R), the current can be reduced by a factor of ½. Thus, using more copper (or aluminum, or silver, or whatever material you desire) wire by doubling the coil windings the results in a correspondingly lower amount of current. Reducing the amount of current required to generate the magnetic field improves the efficiency of the electric motor because the lower the input current required to generate the magnetic field required to power the engine, the greater the efficiency of the motor.

There are three main consequences of increasing the number of windings in the coils of electric motors. First, the current is divided by a factor of “X,” where X is a multiplication factor of how many more windings are included in the coils. This multiplies the efficiency by a factor of “X.”

For example, if a motor in an electric vehicle is running at 80% efficiency, and the number of windings in the coils of the motor are increased by a factor of 2, the motor with the increased number of coils will run at 160% efficiency.

To demonstrate the improved efficiency provided by the new coil design, the standard formula for efficiency of electric motors shown in Equation CC below may be applied.

ηₘ=Pₒᵤₜ/Pᵢₙ

where ηₘ=motor efficiency; Pₒᵤₜ=shaft power out (Watt, W); and Pᵢₙ=electric power in to the motor (Watt, W).

If the coil design decreases the amount of current required to generate the electric field for the motor by a factor of X, the above mentioned Pᵢₙ is divided by X, meaning the efficiency is multiplied by X. Also, the heat produced by the windings in the motor is also reduced by a factor of X.

The second consequence of increasing the number of windings in the coils is increased inductance. The inductance of a coil is function of its geometric shape, the flux path from one end to the other outside the core, etc. In AC motors the larger the coil inductance, the slower the coil “charges” up and down. This is a concern in any motor because a motor runs best when the magnetic field is quickly built up and collapsed.

The above can be the reason why a “minimum wire” design is universal. The larger the inductance, the longer the coil takes to build up the magnetic field in and around the coil, and the longer it can take the field to collapse. In DC motors, if the revolution time is less than the coil “charge+discharge” time, it can lose torque, and output power, and therefore efficiency. A formula of coil dimensions and total inductance is reproduced below:

$$L = \frac{0.8 \cdot {a}^{2} \cdot {N}^{2} \cdot {μ}_{r}}{6 \cdot a + 9 \cdot b + 10 \cdot c} i n , μ H$$

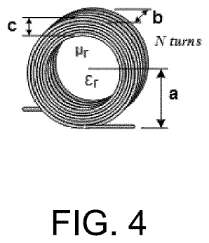

(see FIG. 4 for the variables definitions).

The point of this formula, is to point out that, as the coil is enlarged, the “c” distance provides the most reduction in inductance, followed by “b”, then “a”, which has presence both in the numerator and denominator of the formula, is squared in the numerator! Also note that “c” and “a” are related. Using this formula (which has an indeterminate accuracy at this point in time), one could craft a coil to reduce its total inductance.

The third consequence of having a coil with more windings is the coil can be bigger. Often, the coil is situated in a laminated soft iron core material. The gap for the coil in the laminate may need to made larger to accommodate the larger coil. So, the first thing the motor designer may need to do, is to calculate whether the system will properly function with the added inductance. If not, then they need to scale back the factor “X”. Sometimes, you may have to build a prototype just to insure the proper “X” will work as desired It is hoped that the “minimum wire” design leaves a lot of room for improvement, and allows a greater “X” to be used.

### Motor Implementations of the Coil Design

The coil design principles described above can be applied to various electric motors. In one example, the coil design is implemented in a 5 horsepower DC electric motor running at 3600 rpm. This motor has a power output in watts of 3728.5 watts, therefore, in this embodiment, the coil design is configured to provide at least 3728.5 watts of power output. In various embodiments, the motor receives an electric power input of 240 V through a two-phase connection from the grid. Accordingly, assuming 100% efficiency, the coil of the motor may need to use at least 15.54 amps of electric current flow as shown by the following equation CC:

Amps=(HorsePower×746)/Efficiency/Volts

To design the coils, a wire gauge may be selected based on the required 15.54 amps of current that flow through the coils. For this embodiment, a 14 gauge wire may be selected. The 14 gauge wire has a resistance of 2.58 Ohms per 1000 feet. To reach the 15.54 amps of current the coil must have a total resistance of 15.4 Ohms based on the following equation DD:

R=V/I, so R=240/15.58=15.4 Ohms.

To supply this amount of resistance 5,969 feet of 14 gauge wire can be required. Assuming that the electric motor, however, requires only 1 Tesla of magnetic field to function, therefore, according to equation AA above, for the example 5 hp engine having a magnetic field (B) of 1 Tesla, a soft magnetic core material with a relative magnetic flux density μᵣ, of 8000 and 15.54 amps of current, 6.4 windings are required for the Coil. The 6.4 windings may have a 1 inch inner diameter and may wrapped around laminated soft magnetic core material. In one embodiment, the 6.4 windings may have a total length of 20.4 inches and produce only .0044 Ohms of resistance. The unused 5967 feet of wire required to limit the current to 15.54 amps may be replaced with a 15.4 Ohm resistor for fully DC operation, but most motors rely on the fact that inductance will slow down the rise in current flow, due to “back EMF,” to the extent that full current will never be reached before the cycle of revolution of the motor is reached. This effect of inductance can be thought of as the amount of energy it takes to “push out” the magnet field formed around the wire. The longer the wire, the more the turns of the coil, the more energy it takes to push that magnetic/electric field around the wire.

In other embodiments, the number of windings in the coil design may be doubled, tripled, or otherwise modified to further reduce the current. For example, the length of the coil may be doubled without endangering power, rotation rate, and other motor specs. In one embodiment, the coil design may be implemented in a 5 horsepower motor that only needs 8 amps. The wire gauge selected for this motor may be an 18 gauge copper wire having a resistance of 6.51 Ohms/1000 ft. In various embodiments, the motor receives an electric power input of 240 V through a two-phase connection from the grid. The 8 amp motor may provide 5 Hp at 3600 rpm, and using 1 Tesla of magnetic field. To carry 8 amps, the coil must present 30 Ohms of resistance.

A conventional system would require 4608 feet of wire to achieve the desired resistance, but the coil design described herein may require a coil only 12.43 windings in length. This is roughly double the ˜16 amp situation above, but uses thinner wire. As with the 16 amp example, the resistance of the coil having a length of 12.43 windings is negligible so a 30 Ohm resistor may be required to limit current to 8 amps. Note that 1 Tesla is being generated still, but with only 8 amps and about twice the winding of the first example.

Using the above example, using more and more wire until a maximal inductance is found, above which the motor being designed may not meet its rotational or output power specifications. One can use any approximation method required to “hone in” on the maximal current savings that can be reasonably achieved. A “binary search” is often applicable.

The engine implementation described above may be built using a design process that seeks to minimize the amount of electric current required to generate a predetermined magnetic field strength. Most electric motors are designed assuming the amount of current is the sole indicator of power output. To design a motor based on this assumption, an amount of power that the motor must generate will first be determined. The standard design process then determines the strength of the magnetic field required to deliver the necessary power and the amount of electric current required to produce the magnetic field. The number of coil windings to include in the electric motor are then fixed based on the minimum amount of current required to provide the desired magnetic field. For example, to design the 5 hp motor described above, a standard design process would determine 15.5 A can be required to generate the 5 hp of power.

Traditional assumptions about motor efficiency can support a conclusion that for a 5 hp engine a minimum of 15.5 A of input current can be required because traditional models used to describe motor efficiency assume that the output work could never be greater than the input “work.” However, these traditional models may not account for the shape and orientation of the coils used in electric motors and the additive effect on the magnetic field produced by particular arrangements of the coils. Therefore, standard design processes would not try to reduce the electric current below 15.5 A because this would seemingly defy the 1^{st} law of thermodynamics under traditional models of motor efficiency.

Instead of assuming the electric current is fixed by the law of thermodynamics, the design process used to design the electric motor embodiments described herein can reduce the amount of electric current below the minimum amount of current determined using the standard design process described above by varying the coil design and generating a new model of electric motor efficiency. The design process described herein may not assume the minimum amount of current required to generate the necessary magnetic field is fixed by the laws of thermodynamics.

Instead, the motor design process described herein can determine a minimum amount of current required to generate a desired magnetic field based on the amount of inductance generated by the motor. The calculations used to determine the minimum amount of current may not be limited by the “power in must equal power out” model of motor efficiency mentioned above, instead the solenoid equation is used to determine how much current is required to generate a predetermined magnetic field strength. For example, a new minimum amount of current (I) is determined using the B=N*I relationship described above (with the number of windings (N) is maximized and the desired magnetic field (B) is fixed). The electric motor is then built to include the maximum number of windings and the minimum amount of input current. Therefore, electric motors designed using the processing process designed herein generally can have a larger number of windings of coils and can require a smaller amount of input electric current relative to electric motors designed using the standard design process.

Using the solenoid equation more accurately accounts for the magnetic field generated as current flows over every micron of distance along the wire included in the coils. The magnetic field produced as current flows through the coils is additive therefore dependent of the number of windings as shown in the solenoid equation. The traditional model of motor efficiency does not take the number of windings into account therefore is not relevant for electric motor designs that include coils. It is quite easy to build an electric motor with coils that provides a motor efficiency of over 100% under the traditional efficiency model. This fact demonstrates the outdated nature of the traditional efficiency model and a need for updated efficiency models that are specific to electric motors. Currently, there is no established model for quantifying the efficiency of the conversion of magnetic energy into rotational torque. This efficiency model must account for the geometric relationships of the coils, the shape of the coils, the number of windings, an absolute maximum possible level of efficiency as limited by inductance, and the like.

The coil is truly a wondrous device. And, on top of that, the additive nature of the number of turns to the total field generated is unique to coils. While coils are common practice in electric motors, of which billions in all shapes and sizes are now in service, coils can be designed to give better efficiency in any application requiring them. There is no limitation to the scope, industry, or purposes. If the device uses a coil, these design practices may be helpful in improving the device in question.

In a first embodiment, a process for designing an electric motor is provided. The process can include determining an amount of power output by an electric motor. The process can also include determining a magnetic field strength required to generate the amount of power.

The process can also include determining a theoretical minimum amount of electric current required to generate a magnetic field having the magnetic field strength. The theoretical minimum amount of electric current is based on at least one law of thermodynamics. The process can also include determining an actual minimum amount of electric current based on a number of windings of coils included in the electric motor. The actual minimum amount of electric current is lower than the theoretical minimum amount of electric current and the actual minimum amount of electric current is limited by an inductance of the electric motor. The process can also include building the electric motor to include the number of windings of coils.

In another example embodiment, a system is provided. The system can include at least one rotor, at least one stator, and one or more coils. A number of windings in each of the one or more coils is based on a determination of an amount of power output by an electric motor, a determination of a magnetic field strength required to generate the amount of power output by the electric motor, a determination of a theoretical minimum amount of electric current to generate a magnetic field having the magnetic field strength, and a determination of an actual minimum amount of electric current based on the number of windings in each of the one or more coils included in the electric motor. The actual minimum amount of electric current is lower than the theoretical minimum amount of electric current and the actual minimum amount of electric current is limited by an inductance of the electric motor.

In some instances, the number of windings of each of the one or more coils is increased between 200-300% than an initial number of windings of any of the one or more coils.

In some instances, a length of wire and/or a radius of each of the one or more coils is increased from an initial length of wire and/or an initial radius of any of the one or more coils.

In some instances, the theoretical minimum amount of electric current is based on at least one law of thermodynamics.

In another example embodiment, an electric motor is provided. The electric motor can include one or more coils. A number of windings in each of the one or more coils can be based on determining an amount of power output by an electric motor, determining a magnetic field strength required to generate the amount of power output by the electric motor, determining a theoretical minimum amount of electric current to generate a magnetic field having the magnetic field strength, wherein the theoretical minimum amount of electric current is based on at least one law of thermodynamics, and determining an actual minimum amount of electric current based on the number of windings in each of the one or more coils included in the electric motor, wherein the actual minimum amount of electric current is lower than the theoretical minimum amount of electric current and the actual minimum amount of electric current is limited by an inductance of the electric motor.

In some instances, the number of windings of each of the one or more coils is increased between 200-300% than an initial number of windings of any of the one or more coils.

In some instances, a length of wire and/or a radius of each of the one or more coils is increased from an initial length of wire and/or an initial radius of any of the one or more coils.

In some instances, a gauge of a wire of the one or more coils comprises 14 gauge wire.

In some instances, the one or more coils are disposed around a stator that is positioned adjacent to a rotor, wherein a magnetic field generated by a current flowing through one or more coils is configured to turn the rotor and provide mechanical power.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descriptions pertains that variations and modifications of the various implementations shown and described herein may be made without departing from the spirit and scope of the embodiments. Accordingly, it is intended that the embodiments be limited only to the extent required by the applicable rules of law.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. A system comprising:
at least one rotor;
at least one stator; and
one or more coils, wherein a number of windings in each of the one or more coils is based on:
a determination of an amount of power output by an electric motor;
a determination of a magnetic field strength required to generate the amount of power output by the electric motor;
a determination of a theoretical minimum amount of electric current to generate a magnetic field having the magnetic field strength; and
a determination of an actual minimum amount of electric current based on the number of windings in each of the one or more coils included in the electric motor, wherein the actual minimum amount of electric current is lower than the theoretical minimum amount of electric current and the actual minimum amount of electric current is limited by an inductance of the electric motor.

2. The system of claim 1, wherein the number of windings of each of the one or more coils is increased between 200-300% than an initial number of windings of any of the one or more coils.

3. The system of claim 2, wherein a length of wire and/or a radius of each of the one or more coils is increased from an initial length of wire and/or an initial radius of any of the one or more coils.

4. The system of claim 1, wherein the theoretical minimum amount of electric current is based on at least one law of thermodynamics.

5. An electric motor comprising:
one or more coils, wherein a number of windings in each of the one or more coils is based on:
determining an amount of power output by an electric motor;
determining a magnetic field strength required to generate the amount of power output by the electric motor;
determining a theoretical minimum amount of electric current to generate a magnetic field having the magnetic field strength, wherein the theoretical minimum amount of electric current is based on at least one law of thermodynamics; and
determining an actual minimum amount of electric current based on the number of windings in each of the one or more coils included in the electric motor, wherein the actual minimum amount of electric current is lower than the theoretical minimum amount of electric current and the actual minimum amount of electric current is limited by an inductance of the electric motor.

6. The electric motor of claim 5, wherein the number of windings of each of the one or more coils is increased between 200-300% than an initial number of windings of any of the one or more coils.

7. The electric motor of claim 6, wherein a length of wire and/or a radius of each of the one or more coils is increased from an initial length of wire and/or an initial radius of any of the one or more coils.

8. The electric motor of claim 5, wherein a gauge of a wire of the one or more coils comprises 14 gauge wire.

9. The electric motor of claim 5, wherein the one or more coils are disposed around a stator that is positioned adjacent to a rotor, wherein a magnetic field generated by a current flowing through one or more coils is configured to turn the rotor and provide mechanical power.
